(19) United States
(12) Patent Application Publication
(10) Pub. No.: US 2004/0203296 A1
(43) Pub. Date: Oct. 14, 2004

(54) Method and system for attaching a USB network adapter supporting both RNDIS and non-RNDIS capable operating systems

(75) Inventors: Andrew James Moreton, Cambridge (GB); Shishir Jain, Noida (IN); Krishan Kumar Attre, Faridabad (IN)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: Globespan Virata Inc., Red Bank, NJ (US)

(21) Appl. No.: 10/705,909

(22) Filed: Nov. 13, 2003

Related U.S. Application Data
(60) Provisional application No. 60/426,349, filed on Nov. 15, 2002.

(51) Int. Cl. H01R 9/22

(52) U.S. Cl. 439/894

(57) ABSTRACT

A method and system for attaching a universal serial bus (USB) network adapter that supports both a remote network drive interface specification (RNDIS) capable operating system such as Windows or non-RNDIS capable operating system, such as GPL Linux or Apple Mac OS. In accordance with one embodiment of the present invention, a USB network adapter device is provided with two USB configurations, where the first configuration describes a device that supports the RNDIS protocol (for Windows machines), and the second configuration describes a device that supports the CDC-Ethernet protocol (for non-Windows machines—Linux, Apple Macs). In accordance with another embodiment of the present invention, a device having a single function is provided with multiple configuration to support client drivers of multiple different operating systems without the need of disconnecting or reconfiguring the device. In other words, the device supports two different ethernet traffic encapsulating protocols (RNDIS and CDC-Ethernet) together. Accordingly, the host operating system can dynamically choose which protocol to use.

### CROSS-REFERENCE TO RELATED APPLICATIONS

The present invention claims priority to co-pending U.S. Provisional Patent Application No. 60/426,349, filed Nov. 15, 2002 and entitled “Method and System for Attaching a USB Network Adapter Supporting Both RNDIS and Non-RNDIS Capable Operating Systems”, the entirety of which is incorporated by reference herein.

### BRIEF SUMMARY OF THE INVENTION

The present invention relates generally to the field of universal serial bus (USB) devices and, more particularly, to USB-attached network adapter devices.

Conventionally, USB devices are provided with a configuration protocol designed to enable connectivity with computer systems or other devices running one or more operating systems. In particular, upon connection to an operating system supporting USB devices, the operating system issues a GET_DESCRIPTOR command to the attached device. In response to this command, properly configured USB devices will return a listing of descriptors for its configuration, thereby enabling subsequent communication with the device.

On example of a USB protocol is the remote network drive interface specification or “RNDIS”. RNDIS is a protocol supported by Microsoft for USB-attached network adapters. Accordingly, the adoption of this protocol is desirable in that the Microsoft Corp. supplies all necessary Windows RNDIS “device drivers”. The drivers are shipped as standard with Windows XP™ and available for download and/or OEM distribution for all other Windows versions. Accordingly, this allows USB-attached network adapters such as DSL modems to be used with Windows XP™ without the need for vendor supplied drivers, thus reducing vendor development time, increasing customer/supplier confidence and reducing end-user support queries.

Unfortunately, the legal license available from Microsoft Corp. for the RNDIS protocol prohibits the development and use of RNDIS host support for non-Microsoft operating systems, such as Apple Computer's Mac OS or Linux. The implication of this license thereby implies that a device that only supports the RNDIS protocol cannot be used with personal computers running for example, Mac OS or the GPL Linux operating systems.

The use of multiple Configurations is described in the USB specification. In particular, the specification allows devices to export more than one CONFIGURATION descriptor, and the host can retrieve these descriptors (and associated Interfaces and Endpoints) by sending a GET_DESCRIPTOR command to the device. A device can only support one Configuration at a time, and the host selects the active Configuration by sending a SET_CONFIGURATION message to the device. It should be understood that multiple configurations for USB devices was supported in the USB standard to allow the combination of multiple functional elements within single device. Each functional element corresponds to a client driver. However, since only one such functional element within a device can be active at one time, in order to use the various functions, it is required that the host have the capability to switch from one functionality to another without rebooting or disconnecting the device.

When Microsoft designed its USB stack for the Windows family of operating systems, it decided that it would not support multiple USB Configurations directly, as the normal Plug and Play mechanisms in Windows provided sufficient functionality. Accordingly, when a Windows host first connects to a USB device and issues GET_DESCRIPTOR commands to retrieve Device, Configuration, Interface and Endpoint descriptors from the device, the Windows host simply uses the first Configuration returned from the device, and ignores any other Configurations that the device supports (and provides descriptors for). Upon receipt of a configuration, the Windows Plug and Play Manager then uses information from the device descriptor to identify a device and to find an entry in a .INF installer script (or the Windows registry) to load or install the appropriate device driver.

Turning now to operation under the Linux operation system, when a Linux host connects to the USB device, it also issues a series of GET_DESCRIPTOR commands to retrieve descriptors from the device. However a Linux machine will retrieve all of the available Configuration descriptors, rather than just the first configuration as in the case of Windows. The Linux host then calls a probe( ) routine in each of the available device drivers to determine if that driver is the right one for the new device. The driver's probe( ) routine examines the entire list of Configuration descriptors to decide if the driver can support the new device.

Because Windows operating systems inherently include all device drivers necessary to operate a device using the RNDIS protocol, it is desirable to support the RNDIS protocol for USB devices on Windows. Additionally, a standard for ethernet network devices, known as the Communications and Data Class—Ethernet Networking Model (“CDC-Ethemet”) standard has also been developed by the USB Forum for other operating systems. Drivers for CDC-Ethernet are already available for this standard in Linux machines, and can be written for machines running Mac OS.

The use of both protocols requires a USB network adapter to support RNDIS client firmware to communicate with Windows hosts, and to support CDC-Ethernet to communicate with non-Windows hosts, since the two protocols are incompatible.

Alternative schemes for dual RNDIS/CDC-Ethernet protocol support would require the user to adjust a switch on the device to select the operating mode, or to reconfigure the device firmware or host software. Other alternatives would include building different devices to support Windows and non-Windows hosts. However, this method can result in a substantial increase in development costs to developers and inconvenience to end users.

Accordingly, there is a need in the art of USB network adapters for a USB adapter which supports both RNDIS and other operating configurations.

### SUMMARY OF THE INVENTION

The present invention overcomes the problems noted above, and provides additional advantages, by providing a system and method for enabling the RNDIS protocol to be used with personal computers running the Windows operating system and another protocol when connected to personal computers not running the Windows operating system, without requiring the need to change the firmware image for the device or otherwise manually change the configuration of the device. In accordance with one embodiment of the present invention, a USB network adapter device is provided with two USB configurations, where the first configuration describes a device that supports the RNDIS protocol (for Windows machines), and the second configuration describes a device that supports the CDC-Ethernet protocol (for non-Windows machines—Linux, Apple Macs). In accordance with another embodiment of the present invention, a device having a single function is provided with multiple configuration to support client drivers of multiple different operating systems without the need of disconnecting or reconfiguring the device. In other words, the device supports two different ethernet traffic encapsulating protocols (RNDIS and CDC-Ethernet) together. Accordingly, the host operating system can dynamically choose which protocol to use.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention can be understood more completely by reading the following Detailed Description of the Preferred Embodiments, in conjunction with the accompanying drawings, in which:

FIG. 1 is a flow diagram illustrating one embodiment of a method for configuring a USB-attached network adapter to support both RNDIS and CDC-Ethernet configurations.

FIG. 2 is a flow diagram illustrating one example of a method for configuring a USB network adapter to operate on a dual-boot PC hosting both Microsoft Windows and the Linux operating systems.

FIG. 3 is a flow diagram illustrating one embodiment of a method for configuring a USB network adapter to support both RNDIS and CDC-Ethernet protocols.

### DETAILED DESCRIPTION OF INVENTION

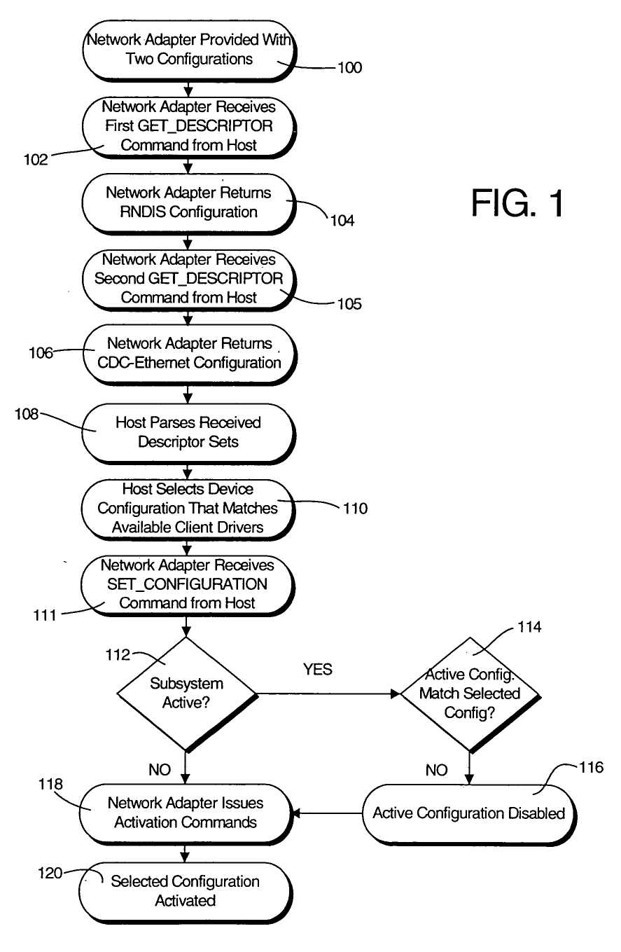

Referring to the Figures and, in particular, to FIG. 1, there is shown a flow diagram illustrating one embodiment of a method for configuring a USB-attached network adapter to support both RNDIS and CDC-Ethernet configurations for Microsoft Windows and non-Windows operating systems.

In general, a USB device is self-describing, and exports a number of descriptors that the USB host may fetch to determine the capabilities of the device. Each device is provided with one or more Configurations, each of which contains one or more Interfaces. Each interface is a collection of Endpoints, which are the channels used to transfer data between the host and the device. Each Interface may also have one or more Alternatives, which describe a variation of the Interface capabilities.

In accordance with one embodiment of the present invention, a USB network adapter device is provided with two USB configurations in step 100. The first configuration describes a device that supports the RNDIS protocol (for Windows machines). The second configuration describes a device that supports the CDC-Ethernet protocol (for non-Windows machines—Linux, Apple Macs).

The descriptor lists include two Alternate Settings for the Data Class Interface in the CDC Ethernet Configurations. This is to allow the host drivers to configure the Data Class Interface without allowing any network traffic to be transferred.

In step 102, the network adapter receives an first GET_DESCRIPTOR request from a host. In response, the network adapter returns the descriptor set associated with the RNDIS configuration. If the “bNumConfigurations” field in the DEVICE descriptor exchanged earlier between the host and the network adapter indicates multiple supported configurations, a second GET_DESCRIPTOR request is generated in step 105. In response, the network adapter returns the descriptor set associated with the CDC-Ethernet configuration in step 106. Next, in step 108, the host parses these configurations to find the configuration supported by the device. Next, in step 110, the host then selects the configuration which matches the client driver (RNDIS for Windows and CDC-Ethernet for non-Windows). Because only one configuration for a USB device may be active at any one time, the device must determine whether its configuration status needs modified upon receipt of a SET_CONFIGURATION issued by the host in step 111. Each configuration inside the network adapter corresponds to a particular subsystem. The first configuration is for RNDIS subsystem and the second configuration is for CDC-Ethernet subsystem. Accordingly, in step 112, the network adapter, upon receiving the Set Configuration internally determines if any subsystem corresponding to any configuration is marked as active or not. If some configuration (e.g., subsystem) is marked as active then the network adapter device determines whether the active configuration matches the configuration selected by the host in step 114. If so, no action is taken. However, if the presently active configuration does not match the selected configuration (i.e., following a reboot in the other OS), the network adapter issues a command to disable the currently active subsystem in step 116. After this step, the network adapter issues commands in step 118 to activate the new subsystem corresponding to the new configuration selected by host. The network adapter then marks this subsystem as active subsystem in step 120.

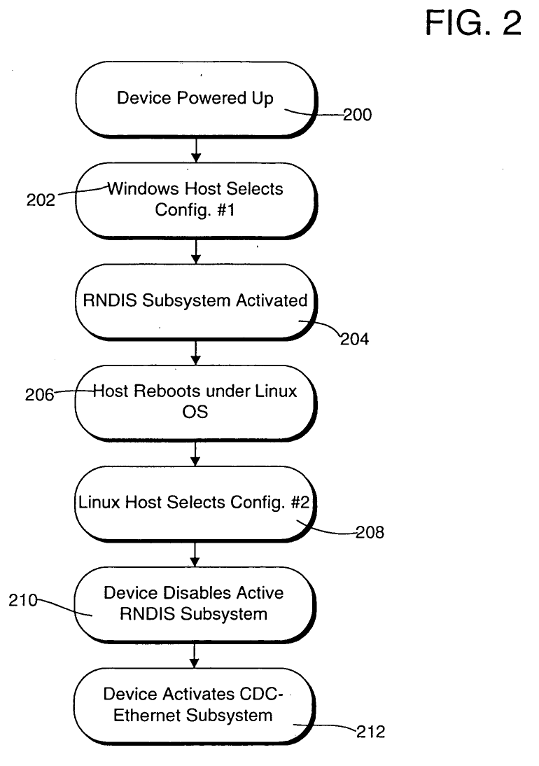

Referring now to FIG. 2, there is shown a flow diagram illustrating one example of a method for configuring a USB network adapter to operate on a dual-boot PC hosting both Microsoft Windows and the Linux operating systems in accordance with the present invention. In step 200, when the device is first powered up, none of the devices is marked as active. Upon connection to a PC booted with Microsoft Windows, the host selects the first configuration which corresponds to the RNDIS subsystem inside the network adapter in step 202.

On a Windows machine, the built in USB driver stack uses the first configuration reported by the device, and ignores any others, so only Configuration #1 will be used. Windows XP (and later) machines will load the built-in Remote NDIS Ethernet driver—Windows 98, Windows 98 SE, Windows Me and Windows 2000 machines do not have Remote NDIS drivers built in, and the user will need to install redistributable Remote NDIS drivers from Microsoft. All these drivers check and use only the first USB configuration—they ignore all further possible configurations.

The RNDIS subsystem is then activated in step 204. Next, in step 206, the host reboots using Linux operating system. In this circumstance, the host selects the second configuration corresponding to CDC subsystem inside the USB device in step 208. In step 210, the USB device first issues commands to disable the already active RNDIS subsystem and then issues commands in step 212 to activate the newly selected subsystem for CDC-Ethernet.

The CDC-Ethernet drivers supplied as standard in Linux (2.14-18 kernel and later) probe all available USB Configurations to locate the required USB Interfaces. The Linux ACM driver will not be loaded for Config #1, because Remote NDIS uses a vendor-specific Interface protocol in the Communications Class Interface. The Linux CDC-Ethernet driver will be loaded for Configuration #2 as this matches the CDC-Ethernet requirements.

The Apple Macintosh CDC-Ethernet drivers for machines (both OS 9 and OS X) may be written and supplied the firmware developer. These drivers are designed to probe all available USB Configurations to locate the required USB Interfaces. The Apple Macintosh CDC-Ethernet driver will be loaded for Config #2 as this matches the CDC-Ethernet requirements.

In accordance with the present invention, a device having a single function is provided with multiple configuration to support client drivers of multiple different operating systems without the need of disconnecting or reconfiguring the device. In other words, the device supports two different ethernet traffic encapsulating protocols (RNDIS and CDC-Ethernet) together. Accordingly, the host operating system can dynamically choose which protocol to use.

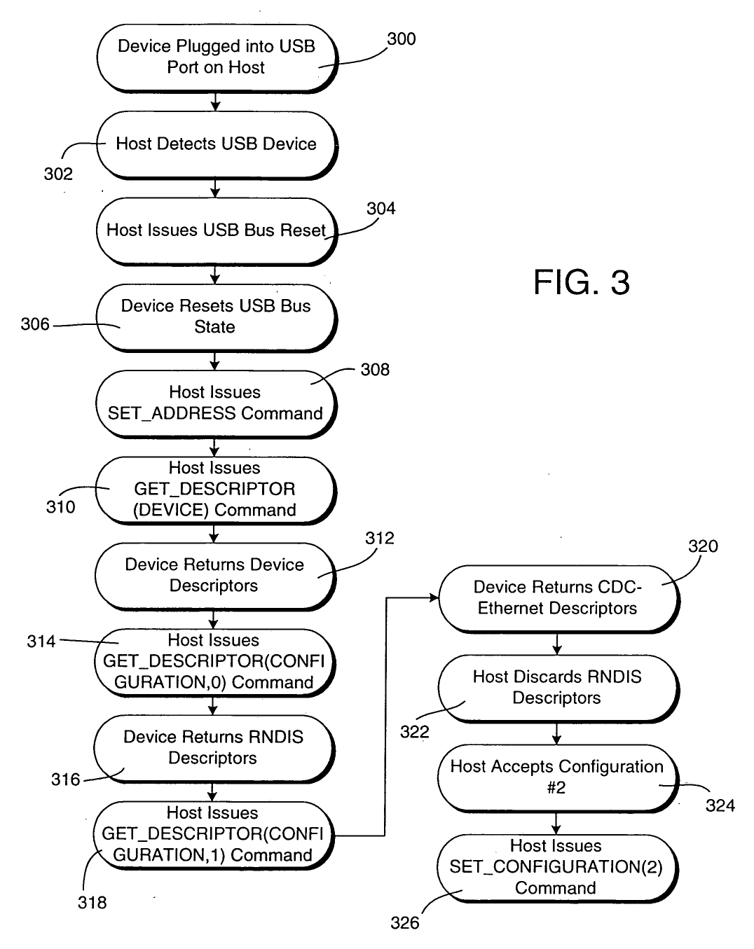

Referring now to FIG. 3, there is shown a flow diagram illustrating one embodiment of a method for configuring a USB network adapter to support both RNDIS and CDC-Ethernet protocols in accordance with the present invention. In step 300, the network device is plugged into a USB port on the host. Next, in step 302, the host detects the new USB device and, in step 304 issues a USB Bus Reset to the device. In step 306, the device resets its state thereby disabling either RNDIS or CDC-Ethernet if previously set.

Next, in step 308, the host issues a SET_ADDRESS command enabling the device to communicate on the USB bus. In step 310, the host issues a GET_DESCRIPTOR(DEVICE) command. In response, the device returns its DEVICE descriptor which indicates the function of the device and the number of configurations it supports in step 312. Next, the host issues a GET_DESCRIPTOR(CONFIGUR-ATION,0) command in step 314. In response, the device returns a list of descriptors for Configuration #1 (RNDIS) in step 316. In step 318, the host issues a GET_DESCRIP-TOR (CONFIGURATION,1). In response, the device returns a list of descriptors for Configuration #2 (CDC-Ethernet) in step 320. Because non-Windows hosts do not support RNDIS drivers, the host discards Configuration #1 as it cannot find a device driver for RNDIS in step 322. Next, in step 324, the host accepts Configuration #2 as a device driver is available for CDC-Ethernet. In step 326, the host issues a SET_CONFIGURATION(2) command to the device telling the device to use the CDC-Ethernet configuration.

The following is a condensed list of exemplary descriptors for the device:

| | |
|---|---|
| DEVICE | Communications Device Class |
| CONFIGURATION | Config #1: Remote NDIS Ethernet |
| INTERFACE | Communications Class Interface, Abstract |
| | Control Model, Vendor Protocol |
| CS_INTERFACE | Communications Class Header |
| CS_INTERFACE | Communications Class Call Management |
| CS_INTERFACE | Communications Class Abstract |
| | Control Management |
| CS_INTERFACE | Communications Class Union |
| ENDPOINT | Notification Endpoint (Interrupt IN) |
| INTERFACE | Data Class Interface (Alternate #0) |
| ENDPOINT | Bulk IN |
| ENDPOINT | Bulk OUT |
| CONFIGURATION | Config #2: CDC Ethernet |
| INTERFACE | Communications Class Interface, Ethernet |
| | Networking Model |
| CS_INTERFACE | Communications Class Header |
| CS_INTERFACE | Communications Class Call Management |
| CS_INTERFACE | Communications Class Abstract |
| | Control Management |
| CS_INTERFACE | Communications Class Union |
| ENDPOINT | Notification Endpoint (Interrupt IN) |
| INTERFACE | Data Class Interface (Alternate #0) |
| INTERFACE | Data Class Interface (Alternate #1) |
| ENDPOINT | Bulk IN |
| ENDPOINT | Bulk OUT |

The list below shows an expanded version of the exemplary descriptor list given earlier, with the important fields shown (lengths etc. are omitted):

| | | |
|---|---|---|
| Device Descriptor: | | |
| bDescriptorType | 01h | DEVICE |
| bcdUSB | 0110h | USB v1.1 |
| bDeviceClass | 02h | Communications Device Class |
| bDeviceSubClass | 00h | Unused |
| bDeviceProtocol | 00h | Unused |
| bNumConfigurations | 02h | Two configurations |
| Configuration Descriptor: | | |
| bDescriptorType | 02h | CONFIGURATION |
| bNumInterfaces | 02h | Two interfaces |
| bConfigurationValue | 01h | Configuration #1 |
| | | (Remote NDIS Ethernet) |
| Communications Class | | |
| Interface Descriptor: | | |
| bDescriptorType | 04h | INTERFACE |
| bInterfaceNumber | 00h | Interface #0 |
| bAlternateSetting | 00h | Alternate #0 |
| bNumEndpoints | 01h | One endpoint |
| bInterfaceClass | 02h | Communication Interface Class |
| bInterfaceSubclass | 02h | Abstract Control Model |
| bInterfaceProtocol | FFh | Vendor-specific protocol |
| Communications Class | | |
| Header Functional | | |
| Descriptor: | | |
| bDescriptorType | 24h | CS_INTERFACE |
| bDescriptorSubtype | 00h | Header Functional Descriptor |
| bcdCDC | 0110h | CDC v1.1 |
| Communications Class | | |
| Call Management | | |
| Functional Descriptor: | | |
| bDescriptorType | 24h | CS_INTERFACE |
| bDescriptorSubtype | 01h | Call Management Descriptor |
| bmCapabilities | 00h | Device does not handle |
| | | Call Management itself |
| bDataInterface | 00h | Unused |
| Communications Class | | |
| Abstract Control | | |
| Management | | |
| Functional Descriptor: | | |
| bdescriptorType | 24h | CS_INTERFACE |
| bDescriptorSubtype | 02h | Abstract Control Management |
| | | Descriptor |
| bmCapabilities | 00h | None |
| Communications | | |
| Class Union | | |
| Functional Descriptor: | | |
| bDescriptorType | 24h | CS_INTERFACE |
| bDescriptorSubtype | 06h | Union Functional Descriptor |
| bMasterInterface | 00h | Interface #0 is Communication |
| | | Class Interface |
| bSlaveInterface0 | 01h | Interface #1 is Data Class Interface |
| Notification Endpoint | | |
| Descriptor: | | |
| bDescriptorType | 05h | ENDPOINT |
| bEndpointAddress | 81h | Endpoint #1 IN |
| bmAttributes | 03h | Interrupt endpoint |
| Data Class | | |
| Interface Descriptor: | | |
| bDescriptorType | 04h | INTERFACE |
| bInterfaceNumber | 01h | Interface #1 |
| bAlternateSetting | 00h | Alternate #1 |
| bNumEndpoints | 02h | Two endpoints |
| bInterfaceClass | 0Ah | Data Interface Class |
| bInterfaceSubclass | 00h | Unused |
| bInterfaceProtocol | 00h | Unused |
| Endpoint Descriptor: | | |
| bDescriptorType | 05h | ENDPOINT |
| bEndpointAddress | 82h | Endpoint #2 IN |
| bmAttributes | 02h | Bulk endpoint |
| EndpointDescriptor: | | |
| bDescriptorType | 05h | ENDPOINT |
| bEndpointAddress | 03h | Endpoint #3 OUT |
| bmAttributes | 02h | Bulk endpoint |
| Configuration Descriptor: | | |
| bDescriptorType | 02h | CONFIGURATION |
| bNumInterfaces | 02h | Two interfaces |
| bConfigurationValue | 02h | Configuration #2 (CDC-Ethernet) |
| Communications Class | | |
| Interface Descriptor: | | |
| bDescriptorType | 04h | INTERFACE |
| bInterfaceNumber | 00h | Interface #0 |
| bAlternateSetting | 00h | Alternate #0 |
| bNumEndpoints | 01h | One endpoint |
| bInterfaceClass | 02h | Communication Interface Class |
| bInterfaceSubclass | 06h | Ethernet Networking Model |
| bInterfaceProtocol | 00h | Unused |
| Communications | | |
| Class Header | | |
| Functional Descriptor: | | |
| bDescriptorType | 24h | CS_INTERFACE |
| bDescriptorSubtype | 00h | Header Functional Descriptor |
| bcdCDC | 0110h | CDC v1.1 |
| Communications Class | | |
| Ethernet Networking | | |
| Functional Descriptor: | | |
| bDescriptorType | 24h | CS_INTERFACE |
| bDescriptorSubtype | 01h | Call Management Descriptor |
| bmCapabilities | 00h | Device does not handle |
| | | Call Management itself. |
| bDataInterface | 00h | Unused |
| Communications | | |
| Class Ethernet | | |
| Networking | | |
| Functional Descriptor: | | |
| bdescriptorType | 24h | CS_INTERFACE |
| bDescriptorSubtype | 02h | Abstract Control |
| | | Management Descriptor |
| bmCapabilities | 00h | None |
| Communications Class | | |
| Union Functional | | |
| Descriptor: | | |
| bDescriptorType | 24h | CS_INTERFACE |
| bDescriptorSubtype | 06h | Union Functional Descriptor |
| bMasterInterface | 00h | Interface #0 is Communication |
| | | Class Interface |
| bSlaveInterface0 | 01h | Interface #1 is Data Class Interface |
| Notification Endpoint | | |
| Descriptor: | | |
| bDescriptorType | 05h | ENDPOINT |
| bEndpointAddress | 81h | Endpoint #1 IN |
| bmAttributes | 03h | Interrupt endpoint |
| Data Class Interface | | |
| Descriptor: | | |
| bDescriptorType | 04h | INTERFACE |
| bInterfaceNumber | 01h | Interface #1 |
| bAlternateSetting | 00h | Alternate #0 |
| bNumEndpoints | 00h | No endpoints |
| bInterfaceClass | 0Ah | Data Interface Class |
| bInterfaceSubclass | 00h | Unused |
| bInterfaceProtocol | 00h | Unused |
| Data Class | | |
| Interface Descriptor: | | |
| bDescriptorType | 04h | INTERFACE |
| bInterfaceNumber | 01h | Interface #1 |
| bAlternateSetting | 00h | Alternate #1 |
| bNumEndpoints | 02h | Two endpoints |
| bInterfaceClass | 0Ah | Data Interface Class |
| bInterfaceSubclass | 00h | Unused |
| bInterfaceProtocol | 00h | Unused |
| Endpoint Descriptor: | | |
| bDescriptorType | 05h | ENDPOINT |
| bEndpointAddress | 82h | Endpoint #2 IN |
| bmAttributes | 02h | Bulk endpoint |
| Endpoint Descriptor: | | |
| bDescriptorType | 05h | ENDPOINT |
| bEndpointAddress | 03h | Endpoint #3 OUT |
| bmAttributes | 02h | Bulk endpoint |

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed:

1. A method for attaching a universal serial bus network adapter supporting both a remote network drive interface specification and a non-network drive interface specification, comprising the steps of:
providing two universal serial bus configurations to a universal serial bus network;
receiving by a network adapter a first request from a host;
returning a remote network drive interface specification configuration from the network adapter;
receiving by the network adapter a second request from a host, when there is an indication of multiple support configurations;
returning a non-remote network drive interface specification configuration from the network adapter;
parsing all the received configuration to determine the configuration supported by the device;
selecting by the host the configuration that matches a client driver;

2. The method of claim 1, wherein the client driver is a remote network drive interface specification (RNDIS).

3. The method of claim 1, wherein the client driver is a communications data class Ethernet (CDC-Ethernet).

4. The method of claim 1, wherein the network adapter determines whether any sub-system that corresponds to any configuration is currently active.

5. The method of claim 1, wherein the network adapter determines whether the active configuration matches the currently active sub-system, the method further comprising issuing a command to disable the sub-system when there is no match, and issuing a command to activate a new sub-system corresponding to the new configuration selected by the host.

7. A method for attaching universal serial bus devices network adapter supporting both remote network drive interface specification and non-network drive interface specification, comprising the steps of:
plugging a network device into a universal serial bus port on a host;
detecting the network device by the host;
issuing a universal serial bus reset to the network device by the host;
resetting the state of the network device;
issuing by the host a command enabling the network device to communicate on the universal serial bus;
issuing by the host a command enabling to retrieve device descriptors from the network device;
returning by the network device a device descriptor indicating its function; and
issuing by the host configuration commands, whereby, the network device returns a list of descriptors.

8. The method of claim 7, wherein the resetting of the state of the network device involves disabling one of a remote network drive interface specification (RNDIS) and a communications data class Ethernet (CDC-Ethernet).

9. The method of claim 7, wherein the list of descriptors for the configuration commands are for a remote network drive interface specification (RNDIS) or a communications data class Ethernet (CD C-Ethernet).

10. The method of claim 7, wherein the host discards the configuration for a remote network drive interface specification (RNDIS).

11. The method of claim 7, wherein the host accepts the configuration for the communications data class Ethernet (CDC-Ethernet).

12. The method of claim 7, wherein the host issues a configuration to the device to use the communications data class Ethernet (CDC-Ethernet) configuration.

13. An apparatus for attaching universal serial bus devices network adapter supporting both remote network drive interface specification and non-network drive interface specification, comprising the steps of:
a universal serial bus network to receive two universal serial bus configurations;
a host to receive a first request from a network adapter;
a network adapter for returning a remote network drive interface specification configuration;
the network adapter receiving a second request from a host, when there is an indication of multiple support configurations;
means for parsing all the received configuration to determine the configuration supported by the device; and
the host selecting the configuration that matches a client driver.

14. The apparatus of claim 13, wherein the client driver is a remote network drive interface specification (RNDIS).

15. The apparatus of claim 13, wherein the client driver is a communications data class Ethernet (CDC-Ethernet).

16. The apparatus of claim 13, wherein the network adapter determines whether any sub-system corresponds to any configuration is active.

17. The apparatus of claim 13, wherein the network adapter determines whether the active configuration matches the currently active sub-system, issues a command to disable the sub-system when there is no match, and issues a command to activate a new sub-system corresponding to the new configuration selected by the host.

18. An apparatus for attaching a universal serial bus network adapter supporting both remote network drive interface specification and non-network drive interface specification, comprising the steps of:
a network device for plugging into a universal serial bus port on a host;
a host for detecting the network device, and for issuing a universal serial bus reset to the network device by the host, and resetting the state of the network device;
a host for issuing a command enabling the network device to communicate on the universal serial bus;
a host for issuing a command enabling to retrieve device descriptors from the network device;
a network device for returning a device descriptor indicating its function; and
a host issuing configuration commands, whereby, the network device returns a list of descriptors.

19. The apparatus of claim 18, wherein the resetting of the state of the network device involves disabling one of a remote network drive interface specification (RNDIS) and a communications data class Ethernet (CDC-Ethernet).

20. The apparatus of claim 18, wherein the list of descriptors for the configuration commands are for a remote network drive interface specification (RNDIS) or a communications device class Ethernet (CDC-Ethernet).

21. The apparatus of claim 18, wherein the host discards the configuration for a remote network drive interface specification (RNDIS).

22. The apparatus of claim 18, wherein host accepts the configuration for the communications data class Ethernet (CDC-Ethernet).

23. The apparatus of claim 18, wherein the host issues a configuration to the device to use for the communications data class Ethernet (CDC-Ethernet).

24. A system for attaching a universal serial bus network adapter supporting both remote network drive interface specification and non-network drive interface specification, comprising the steps of:
providing two universal serial bus configurations to a universal serial bus network;
receiving by a network adapter a first request from a host;
returning a remote network drive interface specification configuration from the network adapter;
receiving by the network adapter a second request from a host, when there is an indication of multiple support configurations;
returning a non-remote network drive interface specification configuration from the network adapter;
parsing all the received configuration to determine the configuration supported by the device; and
selecting by the host the configuration that matches a client driver.

25. The system of claim 24, wherein the client driver is a remote network drive interface specification (RNDIS).

26. The system of claim 24, wherein the client driver is a communications data class Ethernet (CDC-Ethernet).

27. The system of claim 24, wherein the network adapter determines whether any sub-system that corresponds to any configuration is active.

28. The system of claim 24, wherein the network adapter determines whether the active configuration matches the currently active sub-system, the method further comprising issuing a command to disable the sub-system when there is no match, and issuing a command to activate a new sub-system corresponding to the new configuration selected by the host.

30. A system for attaching a universal serial bus network adapter supporting both remote network drive interface specification and non-network drive interface specification, comprising:
a network device plugged into a universal serial bus port on a host;
the host detecting the network device;
the host issuing a universal serial bus reset to the network device to reset the state of the network device;
the host issuing a command to enable the network device to communicate on the universal serial bus;
the host issuing a command to retrieve device descriptors from the network device;
the host receiving a device descriptor listing indicating its function from the network device; and
the host issuing configuration commands, whereby, the network device returns a list of descriptors.

31. The system of claim 30, wherein the resetting of the state of the network device comprises disabling one of a remote network drive interface specification (RNDIS) and a communications data class Ethernet (CDC-Ethernet).

32. The system of claim 30, wherein the device descriptor listing for the configuration commands are for a remote network drive interface specification (RNDIS) or a communications data class Ethernet (CDC-Ethernet).

33. The system of claim 30, wherein the host discards the configuration for a remote network drive interface specification (RNDIS).

34. The system of claim 30, wherein the host accepts the configuration for the communications data class Ethernet (CDC-Ethernet).

35. The system of claim 30, wherein the host issues a configuration to the device to use the communications data class Ethernet (CDC-Ethernet) configuration.

36. A computer-readable media containing a computer-executable program for attaching a universal serial bus network adapter supporting both remote network drive interface specification and non-network drive interface specification, the program comprising:
one or more instructions for issuing a universal serial bus reset to the network device by the host;
one or more instructions for resetting the state of the network device;
one or more instructions for issuing by the host a command enabling the network device to communicate on the universal serial bus;
one or more instructions for issuing by the host a command enabling to retrieve device descriptors from the network device;
one or more instructions for returning by the network device a computer code device descriptor indicating its function; and
one or more instructions for issuing by the host configuration commands, whereby, the network device returns a list of descriptors.

37. The computer-readable media of claim 36, wherein the one or more instructions for resetting of the state of the network device further comprises one or more instructions for disabling one of a remote network drive interface specification (RNDIS) and a communications data class Ethernet (CDC-Ethernet).

38. The computer-readable media of claim 36, further comprising one or more instructions for discarding the configuration for a remote network drive interface specification (RNDIS).

39. The computer-readable media of claim 36, further comprising one or more instructions for accepting the configuration for the communications data class Ethernet (CDC-Ethernet).

40. The computer-readable media of claim 36, further comprising one or more instructions for issuing a configuration code instructing the device to use the communications data class Ethernet (CDC-Ethernet) configuration.
